(19) United States
(12) Patent Application Publication
(10) Pub. No.: US 2020/0398878 A1
(43) Pub. Date: Dec. 24, 2020

(54) Pool Cue Case Caddy

(71) Applicant: Robert Henle, Bailey, CO (US)

(72) Inventor: Robert Henle, Bailey, CO (US)

(21) Appl. No.: 16/447,412

(22) Filed: Jun. 20, 2019

(51) Int. Cl. B62B 1/00; B62B 1/10; B62B 1/26

(52) U.S. Cl. CPC B62B 1/008; B62B 1/266; B62B 1/10

(57) ABSTRACT

A pool cue case caddy for carrying and securing a pool cue case includes a frame comprising a pair of parallel bars and a handle. A base is coupled to a bottom end of each of the bars and perpendicularly extends forward to support a pool cue case. A support comprises a pair of legs pivotably coupled to the pair of bars and a foot extending between a distal end of each of the legs. The support has a folded position extending towards the top end of the frame and an alternate extended position with the foot contacting the ground and the legs maintaining the frame in a vertical position. A pair of wheels is coupled adjacent the bottom end of each of the pair of bars.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to hand trucks and more particularly pertains to a new hand truck for carrying and securing a pool cue case.

### BRIEF SUMMARY OF THE INVENTION

An embodiment of the disclosure meets the needs presented above by generally comprising a frame comprising a pair of parallel bars and a handle. Each of the bars has a top end and a bottom end and the handle extends between the top end of each of the bars. A base is coupled to the bottom end of each of the bars and perpendicularly extends forward. The base is configured to support a pool cue case. A support comprises a pair of legs pivotably coupled to the pair of bars and a foot extending between a distal end of each of the legs. The support has a folded position extending towards the top end of the frame and an alternate extended position with the foot contacting the ground and the legs maintaining the frame in a vertical position. A pair of wheels is coupled adjacent the bottom end of each of the pair of bars. The pair of wheels makes the caddy rollable when the support is in the folded position and the frame is tilted back to lift the base off the ground.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a pool cue case caddy according to an embodiment of the disclosure.

FIG. 2 is a bottom plan view of an embodiment of the disclosure.

FIG. 3 is a front elevation view of an embodiment of the disclosure.

FIG. 4 is a side elevation view of an embodiment of the disclosure.

FIG. 5 is a rear elevation view of an embodiment of the disclosure.

### DETAILED DESCRIPTION OF THE INVENTION

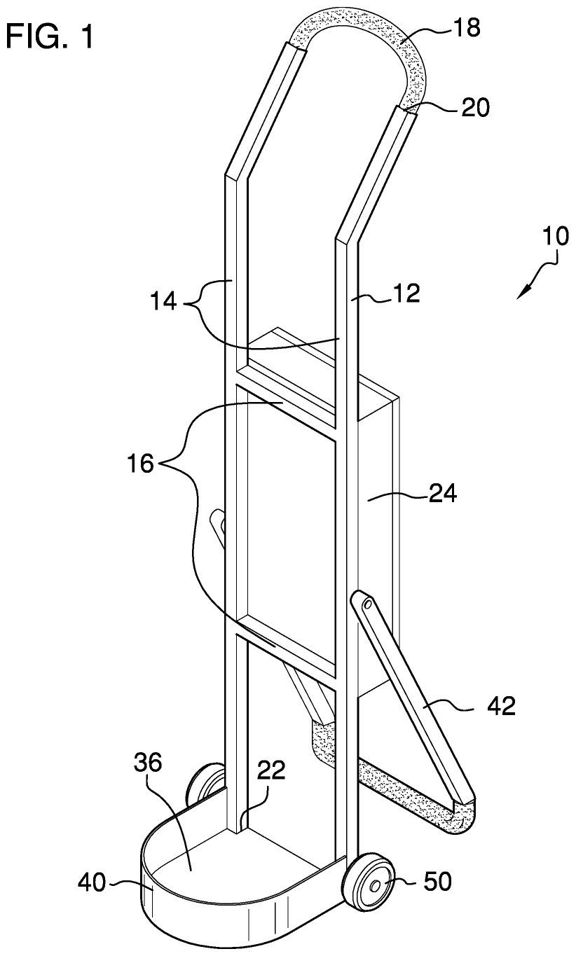

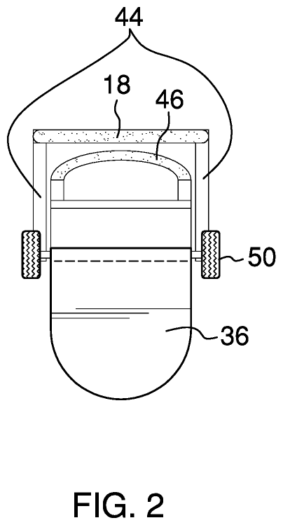

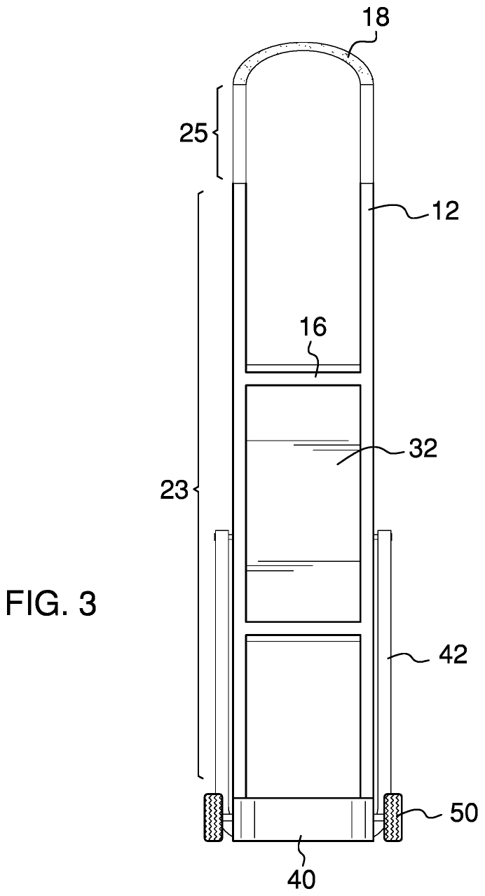

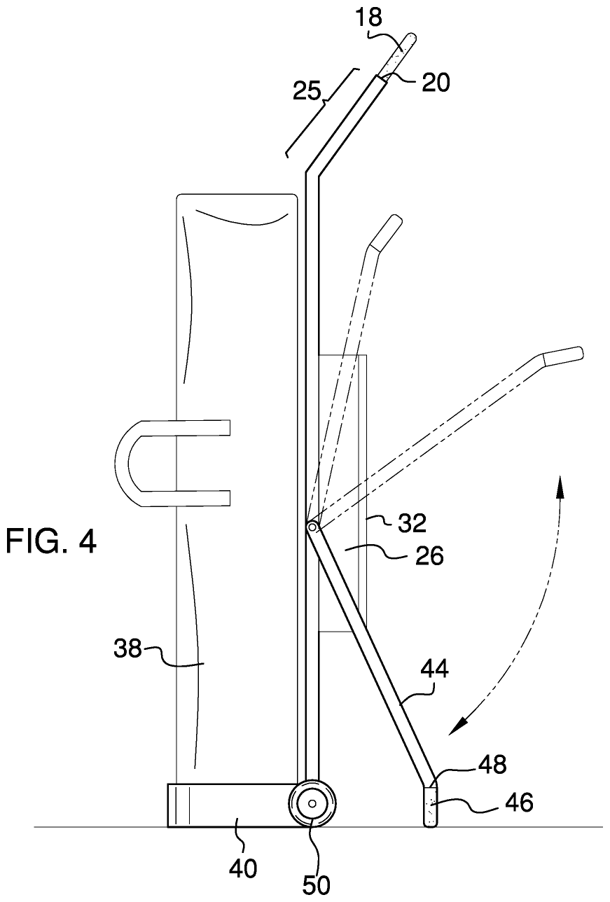

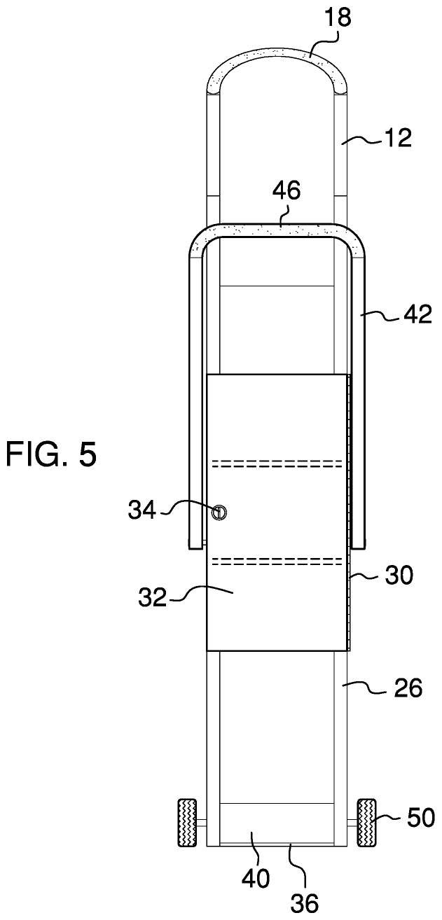

With reference now to the drawings, and in particular to FIGS. 1 through 5 thereof, a new hand truck embodying the principles and concepts of an embodiment of the disclosure and generally designated by the reference numeral 10 will be described.

As best illustrated in FIGS. 1 through 5, the pool cue case caddy 10 generally comprises a frame 12 comprising a pair of parallel bars 14, at least one crossbar 16, and a handle 18. Each of the bars 14 has a top end 20 and a bottom end 22 and the cross bar 16 perpendicularly extends between the pair of bars 14. The handle 18 extends between the top end 20 of each of the bars. The frame 12 may have a vertical section 23 and an angled section 25. The angled section 25 is adjacent the top end 20 and the vertical section 23 has a height configured to be greater than a length of a pool cue case 38.

A tool case 24 is coupled to the frame 12. The tool case 24 comprises a case body 26 coupled to a backside 28 of each of the pair of bars 14 and the crossbar 16. A piano hinge 30 is coupled to the case body 26 and a door 32 is coupled to the piano hinge 30 to swiningly enclose and alternatively expose the case body 26. The door 32 may have a lock 34 to prevent unwanted access to the case body 26.

A base 36 is coupled to the bottom end 22 of each of the bars and perpendicularly extends forward. The base 36 is U-shaped and is configured to match the contour of, and provide support to, the pool cue case 38. A lip 40 is coupled to the perimeter of the base 36 and extends perpendicularly upwards and configured to further secure the pool cue case 38.

A support 42 comprises a pair of legs 44 pivotably coupled to the pair of bars 14 and a foot 46 extending between a distal end 48 of each of the legs 44. The support 42 has a folded position extending towards the top end 20 of the frame and an alternate extended position with the foot 46 contacting the ground and the legs 44 maintaining the frame 12 in a vertical position. The foot 46 may extend at an angle from the pair of legs 44 to allow the pair of legs 44 to lie parallel with the pair of bars 14 of the frame with the support 42 in the folded position without the foot 46 interfering with the frame 12. The frame 12 and the pair of legs 44 may be square tubing and the handle 18 and the foot 46 may be rubber wrapped rod. The square tubing provides flat faces for ease of construction and mounting the tool case 24 to the frame 12, while the rubber wrapped rod provides a more comfortable grip as well as slippage prevention. A pair of wheels 50 is coupled adjacent the bottom end 22 of each of the bars 14. The pair of wheels 50 make the caddy 10 rollable when the support 42 is in the folded position and the frame 12 is tilted back to lift the base 36 off the ground.

In use, the pool cue case 38 is placed on the base 36 and is then wheel around by gripping the handle 18 and tilting the base 36 off the ground with the support 42 in the folded position. When stopped, the base 36 is returned to the ground with the frame 12 vertical and the support 42 is moved to the extended position with the foot 46 contacting the ground.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A pool cue case caddy comprising:
a frame comprising a pair of parallel bars and a handle, each of the bars having a top end and a bottom end, the handle extending between the top end of each of the bars;
a base coupled to the frame, the base being coupled to the bottom end of each of the bars and perpendicularly extending forward, the base being configured to support a pool cue case;
a support coupled to the frame, the support being positioned on an opposite side of the frame relative to the base, the support comprising a pair of legs pivotably coupled to the pair of bars and a foot extending between a distal end of each of the legs, the support having a folded position extending towards the top end of the frame and an alternate extended position with the foot contacting the ground and the legs maintaining the frame in a vertical position; and
a pair of wheels coupled to the frame, the pair of wheels being coupled adjacent the bottom end of each of the bars, the pair of wheels making the caddy rollable when the support is in the folded position and the frame is tilted back to lift the base off the ground.

2. The pool cue case caddy of claim 1 further comprising a tool case coupled to the frame, the tool case being coupled to a back side of each of the bars.

3. The pool cue case caddy of claim 2 wherein the tool case comprises a case body coupled to the frame, a piano hinge coupled to the case body, and a door coupled to the piano hinge, the door enclosing and alternatively exposing the case body.

4. The pool cue case caddy of claim 3 further comprising the door having a lock.

5. The pool cue case caddy of claim 1 further comprising the frame further comprising at least one cross bar, the cross bar perpendicularly extending between the pair of bars.

6. The pool cue case caddy of claim 1 further comprising the frame and the pair of legs being square tubing and the handle and the foot being rubber wrapped rod.

7. The pool cue case caddy of claim 1 further comprising the base being U-shaped and configured to match the contour of the pool cue case.

8. The pool cue case caddy of claim 1 further comprising a lip coupled to the perimeter of the base, the lip extending perpendicularly upwards and configured to further secure the pool cue case.

9. The pool cue case caddy of claim 1 further comprising the frame having a vertical section and an angled section, the angled section being adjacent the top end and the vertical section having a height configured to be greater than a length of the pool cue case.

10. The pool cue case caddy of claim 1 further comprising the foot of the support extending at an angle from the pair of legs, the angle being arranged to allow the pair of legs to lie parallel with the pair of bars of the frame with the support in the folded position without the foot interfering with the frame.

11. A pool cue case caddy comprising:
a frame comprising a pair of parallel bars, at least one crossbar, and a handle, each of the bars having a top end and a bottom end, the cross bar perpendicularly extending between the pair of bars, and the handle extending between the top end of each of the bars, the frame having a vertical section and an angled section, the angled section being adjacent the top end and the vertical section having a height configured to be greater than a length of a pool cue case;
a tool case coupled to the frame, the tool case comprising a case body coupled to a backside of each of the pair of bars and to the crossbar, a piano hinge coupled to the case body, and a door coupled to the piano hinge, the door having a lock and enclosing and alternatively exposing the case body;
a base coupled to the frame, the base being coupled to the bottom end of each of the bars and perpendicularly extending forward, the base being U-shaped and configured to match the contour of, and provide support to, the pool cue case;
a lip coupled to the perimeter of the base, the lip extending perpendicularly upwards and configured to further secure the pool cue case;
a support coupled to the frame, the support being positioned on an opposite side of the frame relative to the base, the support comprising a pair of legs pivotably coupled to the pair of bars and a foot extending between a distal end of each of the legs, the support having a folded position extending towards the top end of the frame and an alternate extended position with the foot contacting the ground and the legs maintaining the frame in a vertical position, the foot extending at an angle from the pair of legs, the angle being arranged to allow the pair of legs to lie parallel with the pair of bars of the frame with the support in the folded position without the foot interfering with the frame;
the frame and the pair of legs being square tubing and the handle and the foot being rubber wrapped rod; and
a pair of wheels coupled to the frame, the pair of wheels being coupled adjacent the bottom end of each of the bars, the pair of wheels making the caddy rollable when the support is in the folded position and the frame is tilted back to lift the base off the ground.
